(19) United States
(12) Patent Application Publication
(10) Pub. No.: US 2015/0081510 A1
(43) Pub. Date: Mar. 19, 2015

(54) Secured Pension Note

(71) Applicant: Goldman, Sachs & Co., New York, NY (US)

(72) Inventors: Christina Minnis, New York, NY (US); Kareem Raymond, Brooklyn, NY (US); Katerina Skorupsky, Cranford, NJ (US); Talal Khan, Princeton, NJ (US)

(73) Assignee: Goldman, Sachs & Co.

(21) Appl. No.: 14/490,356

(22) Filed: Sep. 18, 2014

Related U.S. Application Data
(60) Provisional application No. 61/879,599, filed on Sep. 18, 2013.

(51) Int. Cl. G06Q 40/04; G06Q 20/10

(52) U.S. Cl. CPC G06Q 40/04; G06Q 20/10
USPC 705/37

(57) ABSTRACT

Various aspects of the present disclosure generally relate to facilitating the structuring, issuing, valuing, and redeeming of debt securities, which in turn may be used to fund retirement plans. More specifically, aspects of the present disclosure relate to a Secured Pension Note (the “Note”). In some aspects, for example, Note can be structured to have an initial principal necessary to fully (or partially) fund a pension plan. That is, the plan sponsor contributes the Note to the plan, subject to terms agreed to by an independent fiduciary, to fund the plan. An amount equal to the initial principal amount of the Note is posted as collateral to a third-party. The terms of the Note provide that after the contribution, the principal amount of the Note may be adjusted based on the funded status of the plan (excluding the value of the Note). Upon termination, a portion or all of the funds may be distributed to the pension plan, the plan sponsor, or other third-party.

### CROSS-REFERENCE TO RELATED APPLICATIONS

This application claims priority to U.S. Provisional Application Ser. No. 61/879,599 filed Sep. 18, 2013, which is incorporated in its entirety herein by reference for all purposes.

### TECHNICAL FIELD

Various aspects of the present disclosure generally relate to securities. More specifically, aspects of the present disclosure relate to systems, methods and computer program products for facilitating the structuring, issuing, valuing, and redeeming of debt securities.

### BACKGROUND

The statements in this section merely provide background information related to the present disclosure and may not constitute prior art.

Retirement plans are designed to provide income to individuals once they have left the workforce. Typically, retirement plans fall into defined benefit or defined contribution. Defined benefit plans, such as pensions, are generally contractual obligations between an individual and the individual's former employer for a determined amount. The determined amount can depend on a variety of factors such as years worked at the employer, salary, age at retirement, and others. While there has been a shift towards defined contribution plans, corporate defined benefit pension plans remain a critical source of retirement income for millions of American families. The funded status levels for many corporate defined benefit pension plans, however, have declined significantly in recent years. There are many factors which have contributed to funded status declines over the years. Some include the recent volatility in the equity markets and declines in interest rate levels.

Many plan sponsors that are considering making discretionary contributions to their plans above the minimum required levels to shore up funded status deficits are concerned that market volatility or increases in interest rates will cause their plans to become overfunded, trapping excess funds in the plan; an inefficient use of funds that ultimately benefits neither plan participants nor shareholders. As a result, many plan sponsors may be reluctant to make large discretionary contributions to the plans (leaving plans underfunded or partially funded, which ultimately hurts plan participants).

Given the foregoing, systems, methods, and computer program products are needed that facilitate the structuring, issuing, valuing, and redeeming of debt securities to fund a pension plan without trapping excess funds.

### BRIEF DESCRIPTION OF THE DRAWINGS

Aspects of the present disclosure will be described and explained through the use of the accompanying drawings in which:

FIG. 1 illustrates an example of a networked-based environment in which some aspects of the present disclosure may be utilized;

FIG. 2 is a block diagram illustrating various components of a funding platform in accordance with one or more aspects of the present disclosure;

FIGS. 3A-3B are flowcharts/money-flows illustrating a set of operations for funding a pension plan in accordance with various aspects of the present disclosure;

FIG. 4 is a flowchart illustrating a set of operations for funding a pension plan in accordance with various aspects of the present disclosure;

FIG. 5 is a flowchart illustrating a set of operations for settling a secured pension note in accordance with various aspects of the present disclosure;

FIG. 6 is a sequence diagram illustrating communications between components within a networked-based environment for setting up and managing a secured pension note in accordance with various aspects of the present disclosure; and

FIG. 7 illustrates an example of a computer system with which some aspects of the present disclosure may be utilized.

The drawings have not necessarily been drawn to scale. For example, the dimensions of some of the elements in the figures may be expanded or reduced to help improve the understanding of the aspects of the present disclosure. Similarly, some components and/or operations may be separated into different blocks or combined into a single block for the purposes of discussion of some of the aspects of the present disclosure. Moreover, while the disclosure is amenable to various modifications and alternative forms, specific aspects have been shown by way of example in the drawings and are described in detail below. The intention, however, is not to limit the disclosure to the particular aspects described. On the contrary, the present disclosure covers all modifications, equivalents, and alternatives falling within the scope of the disclosure.

### DETAILED DESCRIPTION

Various aspects of the present disclosure generally relate to facilitating the structuring, issuing, valuing, and redeeming of debt securities, which in turn may be used to fund retirement plans. More specifically, aspects of the present disclosure relate to a Secured Pension Note (the “Note”).

Corporate defined benefit pension plans remain a critical source of retirement income for millions of American families. However, funded status levels for many corporate defined benefit pension plans have declined significantly in recent years. There are many factors that have contributed to funded status declines over the years. Some possible reasons include the recent volatility in the equity markets and declines in interest rate levels.

Many plan sponsors that are considering making discretionary contributions to their plans above the minimum required levels to shore up funded status deficits are concerned that market volatility or increases in interest rates will cause their plans to become overfunded in a short time, trapping excess funds in the plan; an inefficient use of funds that ultimately benefits neither plan participants nor shareholders. As a result, many plan sponsors may be reluctant to make large discretionary contributions to the plans (leaving plans underfunded or partially funded, which ultimately hurts plan participants). Such underfunded pension plans also increase the risk to the Pension Benefit Guaranty Corporation (PBGC)—the independent U.S. government agency which insures private pension plans and must pay plan participants when such plans fail.

To help address these legitimate plan sponsor concerns, various aspects of the present disclosure generally relate to systems and methods for providing the Note, which may be an employer security designed to be issued by plan sponsors, in one possible structure, and contributed to their plans. The Note is designed to encourage plan sponsors to more fully fund their plans, thus increasing the security of plan participant benefits without leaving any resulting surplus locked into the plan and lost to shareholders. In other variants, the Note may be issued by a third-party. For example, the plan sponsor may purchase the Note from the third-party (e.g., based on the principal amount plus the present value of any interest payments to be made) and contribute the Note to the plan.

In some aspects, for example, a Note can be structured to have an initial principal necessary to reach a desired funding level. The desired funding level may partially fund, fully fund, or over fund the plan. That is, the plan sponsor contributes the Note to the plan, subject to terms agreed to by an independent fiduciary, to fund the plan. An amount equal to the initial principal amount of the Note, and, in a legally defeased case, along with the present value of the interest payments, is posted as collateral to a third-party. The terms of the Note provide that after the contribution, the principal amount of the Note will adjust based on the funded status of the plan (excluding the value of the Note). The principal amount cannot increase above the initial principal amount but can decrease to zero based on the funded status of the plan (excluding the value of the Note). In some variants, the principal amount may be contributed into a third-party account according to a funding schedule.

In other variants, when a plan sponsor issues the note, the collateral could be further insured by an insurance company. In some cases, the insurance policy can provide additional protection. For example, if collateral are not cash or U.S. treasuries, the insurance policy can provide protection that cash will be available when it is needed. As another example, when a plan sponsor issues the note, if the plan sponsor is not contributing the collateral to a third party account, insurance could be purchased by plan sponsor on the collateral deliverance.

At maturity of the Note, there are four potential outcomes: (1) Funded status (excluding the Note) remains the same as at the time of issuance: thus, collateral is released and used to repay the Note in full, and the plan is now fully funded; (2) Funded status (excluding the Note) declines from the level at the time of issuance: thus, collateral is released and used to repay the Note in full, and the plan is better funded than it otherwise would have been without the Note; (3) Funded status (excluding the Note) improves from the level at the time of issuance: thus, the principal amount on the Note is reduced to the underfunding in the Plan; the collateral is released, a portion of which is used to repay the remaining principal on the Note and the remaining collateral is returned to plan sponsor; or (4) Plan is now fully funded: thus, funded status (excluding the Note) becomes fully funded, the principal on the Note is reduced to zero, the Note is retired and no payment has been made to the Plan, and all collateral is released and returned to plan sponsor; plan remains fully funded.

As a result, this structure provides plan participants with a secured claim on corporate assets. The structure encourages plan sponsors to fund their pension plans above the minimum required levels without fear that the plan will become significantly overfunded while reducing the prospect that market volatility will discourage plan sponsors from making additional contributions to their plans (to the detriment of plan participants).

Plan sponsors may consider making a note contribution targeting a funded status level on certain basis (i.e., accounting, funding, PBGC, annuity, etc). The funded status level may include underfunded or partially funded levels (e.g., 60%, 70%, 80%, 93%, 3 million under, or other level), fully funded level (i.e., 100% funding level as indicated by the chosen basis), or an overfunded level (e.g., 105%, 110%, 10 million over, etc.)

In the following description, for the purposes of explanation, numerous specific details are set forth in order to provide a thorough understanding of aspects of the present disclosure. It will be apparent, however, to one skilled in the art that aspects of the present disclosure may be practiced without some of these specific details. While, for convenience, aspects of the present technology are described with reference to pension plans, aspects of the present technology are equally applicable to other types of defined benefit plans.

Moreover, the techniques introduced herein to structure, issue, value, and redeem, in an aspect, a debt security in conjunction with funding a retirement plan can be embodied as special-purpose hardware (e.g., circuitry), as programmable circuitry appropriately programmed with software and/or firmware, or as a combination of special-purpose and programmable circuitry. Hence, aspects may include a machine-readable medium having stored thereon instructions that may be used to program a computer (or other electronic devices) to perform a process. The machine-readable medium may include, but is not limited to, floppy diskettes, optical discs, compact disc read-only memories (CD-ROMs), magneto-optical discs, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions. Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some aspects,” “according to some aspects,” “in the aspects shown,” “in other aspects,” and the like generally mean the particular feature, structure, or characteristic following the phrase is included in at least one implementation of the present disclosure, and may be included in more than one implementation. In addition, such phrases do not necessarily refer to the same aspects or different aspects.

If the specification states a component or feature “may”, “can”, “could”, or “might” be included or have a characteristic, that particular component or feature is not required to be included or have the characteristic.

The term “module” or “engine” refers broadly to general or specific-purpose hardware, software, or firmware (or any combination thereof) components. Modules and engines are typically functional components that can generate useful data or other output using specified input(s). A module or engine may or may not be self-contained. Depending upon implementation-specific or other considerations, the modules or engines may be centralized or functionally distributed. An application program (also called an “application”) may include one or more modules and/or engines, or a module and/or engine can include one or more application programs.

### General Description

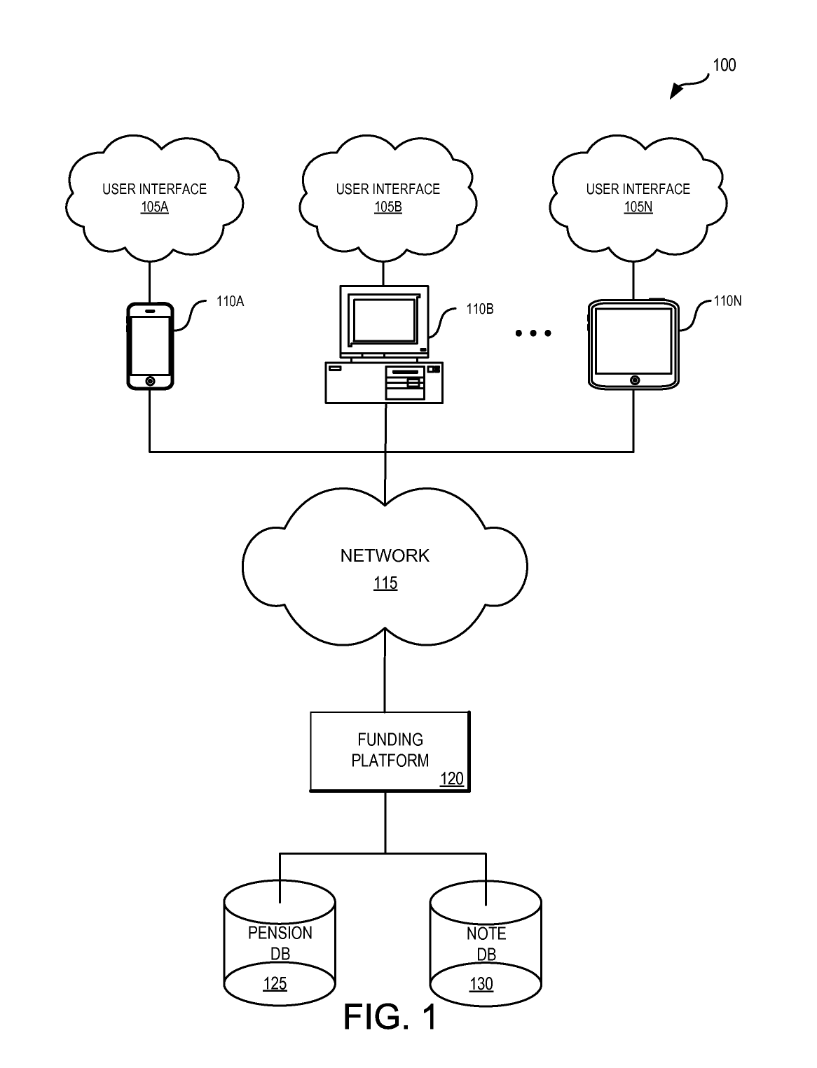

FIG. 1 illustrates an example of a networked-based environment 100 in which some aspects of the present disclosure may be utilized. As illustrated in FIG. 1, user interface 105A-105N running on user devices 110A-110N can use network 115 to access funding platform 120. In accordance with various aspects, user devices 110A-110N may use network 115 to submit and retrieve information regarding the pension plans supported by the company. User devices 110A-110N can interact with funding platform 120 through an application programming interface (API) that runs on the native operating system of the device, such as OS X®, WINDOWS®, IOS® or ANDROID™.

Through funding platform 120, users can analyze and evaluate their pension plan. For example, funding platform may access one or more pension databases 125 to collect information about the current status of a company's pension plan. This information can then be used to determine the current funding status of the pension plan. Once the evaluation is completed, funding platform 120 can setup, monitor, and manage the Note for the company. Information regarding the Note can be stored in note database 130.

User devices 110A-110N can be any computing device capable of receiving user input as well as transmitting and/or receiving data via network 115. In one aspect, user devices 110A-110N can be any device having computer functionality, such as a personal digital assistant (PDA), mobile telephone, smartphone, tablet, personal computer, desktop, server computer, laptop or similar computing device. User devices 110A-110N can be configured to communicate via network 115, which may comprise any combination of local area and/or wide area networks, using both wired and wireless communication systems. In one aspect, network 115 uses standard communications technologies and/or protocols. Thus, network 115 may include links using technologies such as Ethernet, 802.11, worldwide interoperability for microwave access (WiMAX), 3G, 4G, CDMA, Long Term Evolution (LTE), digital subscriber line (DSL), etc.

Similarly, the networking protocols used on network 115 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 115 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

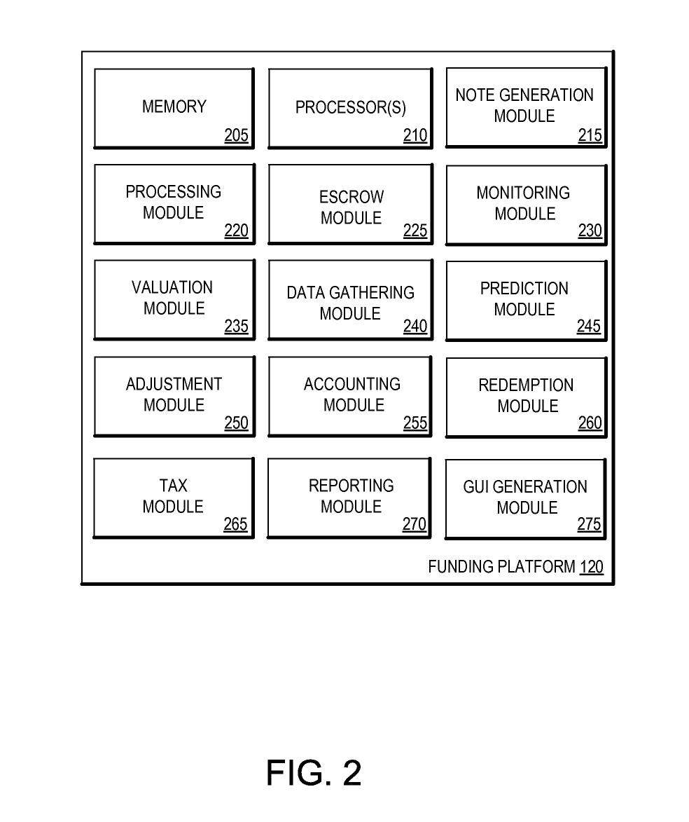

FIG. 2 is a block diagram illustrating various components of funding platform 120 in accordance with one or more aspects of the present disclosure. According to the aspects shown in FIG. 2, funding platform 120 can include memory 205, one or more processors 210, note generation module 215, processing module 220, escrow module 225, monitoring module 230, valuation module 235, data gathering module 240, prediction module 245, adjustment module 250, accounting module 255, redemption module 260, tax module 265, reporting module 270, and graphical user interface (GUI) generation module 275. Other aspects of the present disclosure may include some, all, or none of these modules and components along with other modules, applications, and/or components. Still yet, some aspects may incorporate two or more of these modules and components into a single module and/or associate a portion of the functionality of one or more of these modules with a different module. For example, in one aspect, adjustment module 250 and accounting module 255 can be combined into a single module for managing the secured notes.

Memory 205 can be any device, mechanism, or populated data structure used for storing information. In accordance with some aspects of the present disclosure, memory 205 can encompass any type of, but is not limited to, volatile memory, nonvolatile memory and dynamic memory. For example, memory 205 can be random access memory, memory storage devices, optical memory devices, media magnetic media, magnetic tapes, hard drives, SDRAM, RDRAM, DDR RAM, erasable programmable read-only memories (EPROMs), electrically erasable programmable read-only memories (EEPROMs), compact discs, DVDs, and/or the like. In accordance with some aspects, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more aspects to house all or some of the instructions needed to execute the functionality of note generation module 215, processing module 220, escrow module 225, monitoring module 230, valuation module 235, data gathering module 240, prediction module 245, adjustment module 250, accounting module 255, redemption module 260, tax module 265, reporting module 270, and/or GUI generation module 275.

Note generation module 215 can receive a request from a plan sponsor to issue a Note. The request can be an electronic request and include a variety of information such as, but not limited to, plan sponsor information, issuer, holder, principal amount, maturity, coupon details, guarantors, maximum value, minimum value, company information, pension information, and the like. Using the information in the request, note generation module 215 can then setup the terms and conditions for a Note. The following table is an example of a set of illustrative terms of a Note issued by note generation module 215:

| | |
|---|---|
| Security: | Secured Pension Note (the “Note”) |
| Issuer: | Plan Sponsor |
| Holder: | Plan Sponsor's Master Retirement Trust (the “Plan”) |
| Principal | $[ ] |
| Amount: | |
| Maturity: | [1-20] years |
| Coupon: | Fixed rate of interest, payable in cash quarterly |
| | based on the principal of the Note at inception |
| | Yields on the Note to vary depending on the |
| | structure of the Note, and in certain instances the |
| | credit quality of the issuer for secured financing |
| | with similar maturities |
| Valuation: | The value of the Note to be comprised of: (1) an |
| | interest component and (2) a variable component |
| | Interest component: equal to the present value of |
| | the interest payments on the Note to maturity |
| | Variable component: equal to the value of contracts |
| | on the funded status of the plan (excl. the Note) |
| Guarantors: | Collateral to be held by an independent indenture |
| | trustee subject to the terms of an indenture |
| | agreement |
| Redemption | Issuer call and plan put rights subject to the |
| Rights: | terms of the contribution agreement |
| Covenants | Customary covenants and other conditions for |
| and Other | secured facilities including but not limited to: |
| Conditions: | Limitations on liens |
| | Anti-layering provisions |
| | Change of control provisions |
| | Events of default |

Some versions of the request received by note generation module 215 may include an analysis request asking for a current pension plan to be analyzed in accordance with a set of assumptions, pre-defined stress tests, and/or other valuation criteria. For example, the set of assumptions may include estimates of life expectancy, average working years, cost of living adjustments, pension liability growth, average final salary, expected asset allocation, pension assets returns and correlations, and the like. This additional information may also be used to set the terms and conditions of the Note.

Processing module 220 can process the request and record various terms and conditions or other information about the Note that was included in the request. Examples include, but are not limited to, the issuer, the holder, the principal amount, the maturity date, the coupon, the indexation, the guarantor, the collateral posting schedule (e.g., ⅓ of collateral each year over a three year period or other even, accelerating, or decelerating posting schedule), terms in the issuer agreement, optional features, covenants, and/or other terms and conditions. Some versions of processing module 220 can generate one or more analyses and/or recommendations in response to an analysis request. For example, processing module 220 can compute a recommendation regarding the Note structure, amount, or other details based on the results of the analysis of the pension.

Escrow module 225 can set up an escrow or other third-party collateral account where the initial principal amount can be held and invested in accordance with the terms and conditions set forth by the Note. Monitoring module 230 can monitor the current funded status level of the pension plan. The current funded status level of the pension plan can be computed in a variety of ways and at different frequencies (e.g., daily, weekly, monthly, quarterly, semi-annually, yearly, etc.) or upon detection of various event triggers (e.g., manual request by an independent fiduciary or plan sponsor). For example, actuaries or other entities may be responsible for computing the funded status of the plan. As a result, monitoring module 230 may generate requests to the actuaries or other third-parties to generate or update the current funded status level of the pension plan.

Valuation module 235 can use a variety of techniques for valuing the pension plan and/or the Note. For example, when a plan sponsor proposes to contribute the Note to the Plan, an independent fiduciary can determine that the plan should accept the Note. The independent fiduciary may select an appropriate valuation framework to value the Note on a periodic basis. In accordance with some aspects, the Note can be valued at least annually (but potentially more frequently) to conform with plan and plan sponsor financial reporting requirements. In consultation with the independent fiduciary, the terms of the Note can be periodically restructured so that the value of the Note matches the actual funded status of the plan. For example, if the value of the Note is lower than the actual funded status level, the interest rate on the Note can be increased. If the value of the Note is higher than the actual funded status level, the interest rate on the Note cannot be lowered and the plan will benefit from a higher valuation of the Note.

In accordance with some aspects, valuation module 235 can use a variety multiple valuation components. In other cases, valuation module 235 can use other techniques such as Monte Carlo simulation, backward induction, risk-neutral valuation, cash flow projection, cash flow discounting, historical performance evaluation, scenario analysis, similar instrument comparison, splitting the Note into two or more components and valuing them separately, and incorporating other factors, such as credit risk, funding cost, opportunity cost, or liquidity. As one example, valuation module 235 can use an interest component plus a variable component to value the Note. In some aspects, the Note will pay a (quarterly) fixed rate of interest on the initial principal of the Note until maturity. The stream of interest payments are valued by taking the present value of the future interest payments. The interest rate will depend on how the Note is structured. For example, if structured to be legally defeased, the interest rate will be based on the security of the collateral. If not legally defeased, the interest rate will be based partially on the credit profile of the issuer. The variable component of the Note, in this valuation methodology example, may have a pay-off profile that is tied to the funded status of the plan. In some aspects, the value of the Note can be capped at the initial principal of the Note but could be reduced to zero. This component may be priced similar to the sale of a contract on funded status struck at zero, offset by the purchase of a contract on funded status struck at the plan's current funded status deficit.

At initiation, the value of the Note may be comprised of interest and variable components, per described valuation methodology example. The rate of interest for the Note's interest component will be determined at issuance and is expected to remain constant through maturity of the Note. However, in consultation with the independent fiduciary, if the value of the Note is determined to be lower than the actual funded status level, the interest rate on the Note can be increased. Over time, as the interest approaches maturity, the interest component as a percentage of the total Note value will decline as the present value of future interest payments will decline. At maturity of the Note, 100% of the value of the Note will be derived from the variable component.

Data gathering module 240 may collect information from third-party suppliers regarding market performance. This information may be used by prediction module 245 for generating one or more predictive analyses of the Note and/or plan performance.

Then, adjustment module 250 can adjust the value of the note based on the current funding level. This occurs on a periodic basis (e.g., quarterly, semi-annually, yearly, at maturity, etc.). Accounting module 255 can determine the amount of the escrow that needs to be contributed to the plan and the excess amount, if any, to be returned to the plan sponsor. The excess amount to be returned to the plan sponsor and the amount to be transferred to the plan may be communicated to redemption module 260 which ensures the appropriate distribution of the funds. The determination of the excess amount to be returned to the plan sponsor may be subject to additional rules, if the funds are returned during the term of the Note. In the same example, conversely, the calculation would be performed to determine any additional collateral that the plan sponsor needs to post to a third-party account, if any funds have been returned to the plan sponsor prior to expiry of the Note.

Prior to maturity of the Note, an independent fiduciary of the plan could agree to release of collateral subject to certain conditions. For example, if the level of collateral was equal to more than a set percentage (e.g., 150%) of the value of the Note, the independent fiduciary could release some of the collateral. In some aspects, the plan's independent fiduciary may have a veto right to limit the plan sponsor's access to collateral. There may also be limits on the amount that may be released. For example, a plan sponsor may be able to obtain early release on a maximum of 50% of the initial collateral.

Redemption module 260 may also monitor for a variety of events that would trigger a required transfer of assets from the indenture trustee account to the pension plan. Examples of these events include, but are not limited to the following: 1) Plan sponsor declaration of bankruptcy; 2) Failure to make an interest payment on the Note; 3) Violation of covenants; 4) Change of control; 5) Triggers of plan's put right; and/or 6) Plan termination. If the plan were terminated during the term of the Note, the collateral may be released to the plan as per the terms of the Note indenture.

In accordance with various aspects, the Note and its collateral may or may not survive bankruptcy. For example, in some aspects, the collateral in the indenture account would likely be stayed at the time of a potential bankruptcy filing. Once the stay has ended, the collateral may be released and contributed to the plan at the end of the bankruptcy proceeding. The collateral may or may not be available to other secured, unsecured, and other creditors in a bankruptcy. In some cases, the collateral may be available to the various creditors regardless of whether the collateral is, at any point in time, in excess of the amount of underfunding in the plan. If the collateral were significantly in excess of the underfunding, the bankruptcy rules may permit the debtor to “reject” the note, triggering its default provisions and making it immediately due. As a result, the plan will be given an amount equal to at least the current underfunding, and the rest of the collateral can be used in the bankruptcy to repay creditors.

Contracts are generally not rejected until the end of the bankruptcy proceeding and over-secured notes almost always “ride through” the bankruptcy. Rejecting the note simply means using the collateral to pay off the note. Thus, at the time of the breach, the plan would receive the difference, plus breach damages set forth in the note, between the plan's assets and liabilities in cash from the collateral pool. In accordance with various aspects, there would be no issue with lien perfection. The Note indenture could be structured with a number of covenants that would restrict the plan sponsor's ability to raise any secured debt that would attempt to perfect a lien against the collateral securing the Note. For example, some aspects could include terms and conditions with a “Limitation on Liens” covenant and an “Anti-layering” covenant. The anti-layering covenant, for example, could restrict the ability of the company to incur incremental debt with a more senior claim on the Note's collateral than the Note.

In some aspects, the Note may be treated as a regular way contribution from tax perspective. Tax module 265 can ensure compliance with any requirements needed to receive an appropriate tax treatment. Reporting module 270 can generate one or more reports regarding a pension plan, tax forms, and/or status of the Note.

GUI generation module 275 can generate one or more GUI screens that allow for interaction with a user of funding platform 120. In at least one aspect, GUI generation module 275 generates a graphical user interface screen allowing a user to set preferences, present reports, and/or otherwise receive or convey information.

Examples of other modules which are not illustrated in FIG. 2 but may be used in various aspects include but are not limited to the following: a general-purpose or special-purpose “communications module” for interfacing with components of funding platform 120, a “structuring module” if a third-party acts as a structure of the Note, an “insurance module” if additional insurance is purchased to guarantee collateral, an “encryption module” to encrypt and decrypt communications and information, as well as other modules for providing various functionality needed by aspects of the present disclosure.

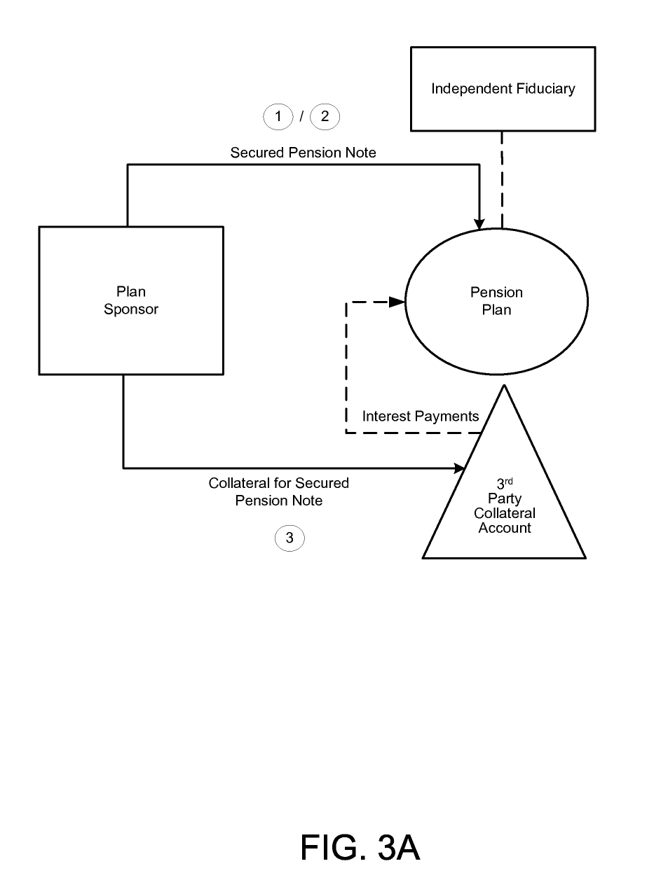

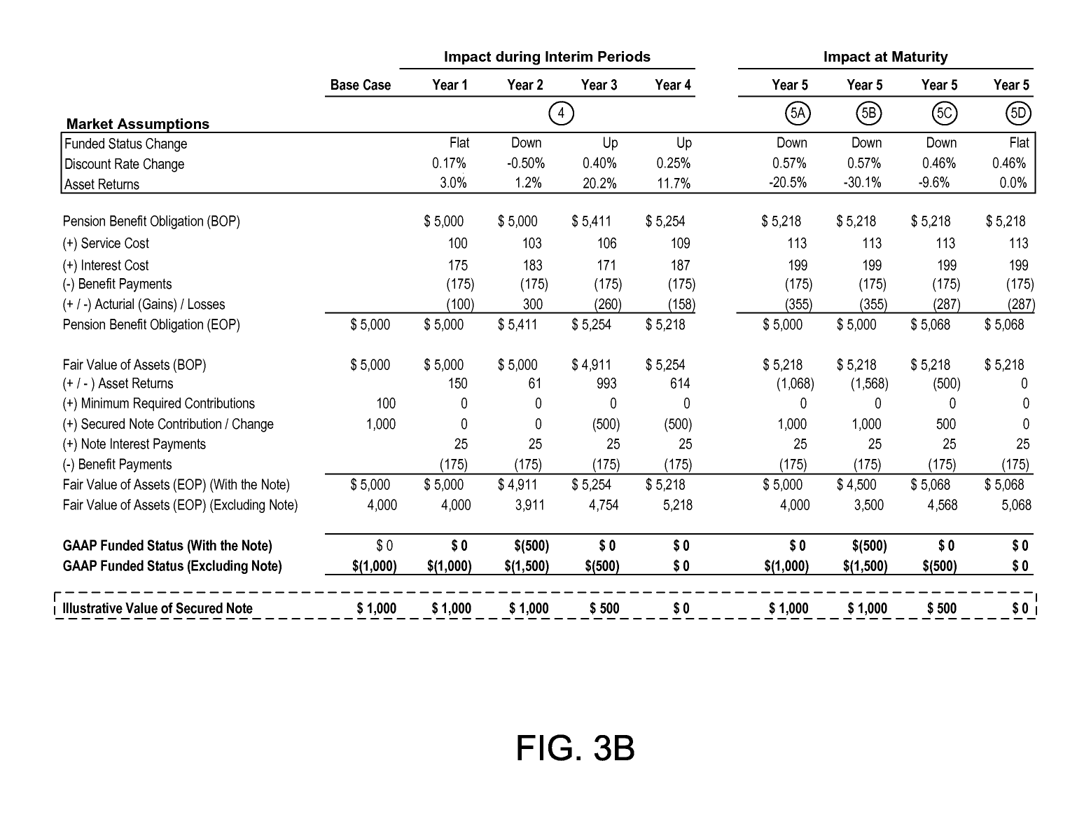

Referring now to FIGS. 3A-3B, flowcharts/money-flows illustrating operations for issuing a Note in order to facilitate the funding of a pension plan, in accordance with various aspects of the present disclosure, are shown.

FIG. 3A-1. Plan sponsor issues a Secured Note with an initial principal amount equal to the current funded status deficit of the plan. (The Note alternatively could be structured with an initial principal equal to a portion of the current funded status deficit, which would result in the plan not being fully funded.) The Note will have a specific maturity date and may have a stated interest payable or accrued quarterly or periodically until maturity.

FIG. 3A-2. Plan sponsor proposes to contribute the Note to the plan, and an independent fiduciary for the plan determines that the plan should “accept” the Note. Plan sponsor contributes the Note to the plan, subject to terms agreed to by the independent fiduciary, to fund the plan.

FIG. 3A-3. An amount equal to the initial principal amount of the Note is posted as collateral to a third-party.

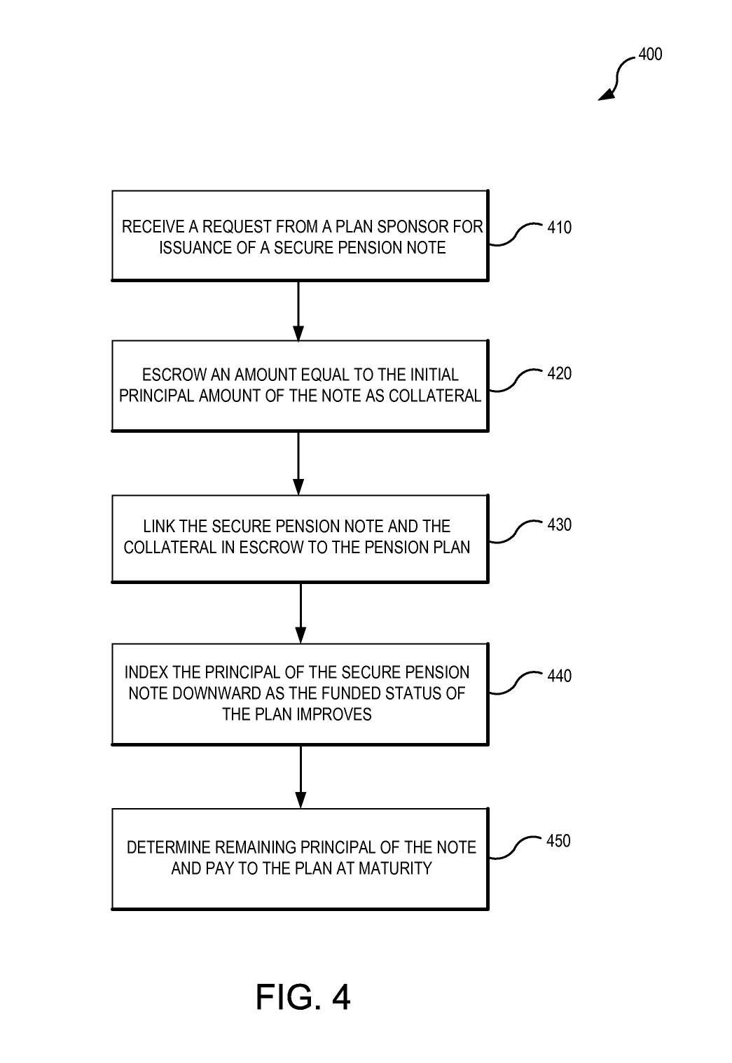

FIG. 3B-4. The terms of the Note may provide that after the contribution, the principal amount of the Note will adjust based on the funded status of the plan (excluding the value of the Note). The principal amount cannot increase above the initial principal amount but can decrease to zero based on funded status of the plan (excluding the value of the Note). The impact of the Note at different market scenarios in the interim period is shown.

FIG. 3B-5A-5D. At maturity of the Note, there are four potential outcomes:

FIG. 3B-5A. Funded status (excluding the Note) remains the same as at issuance. Collateral is released and used to repay the Note in full. Plan is now fully funded.

FIG. 3B-5B. Funded status (excluding the Note) declines from level at issuance. Collateral is released and used to repay the Note in full. Plan is better funded than it otherwise would have been without the Note.

FIG. 3B-5C. Funded status (excluding the Note) improves. The principal amount on the Note is reduced to the underfunding in the Plan. Collateral is released, a portion is used to repay the remaining principal on the Note and the remaining collateral is returned to plan sponsor. Plan is now fully funded.

FIG. 3B-5D. Funded status (excluding the Note) becomes fully funded. The principal on the Note is reduced to zero. The Note is retired and no payment has been made to the Plan. All collateral is released and returned to plan sponsor. Plan remains fully funded.

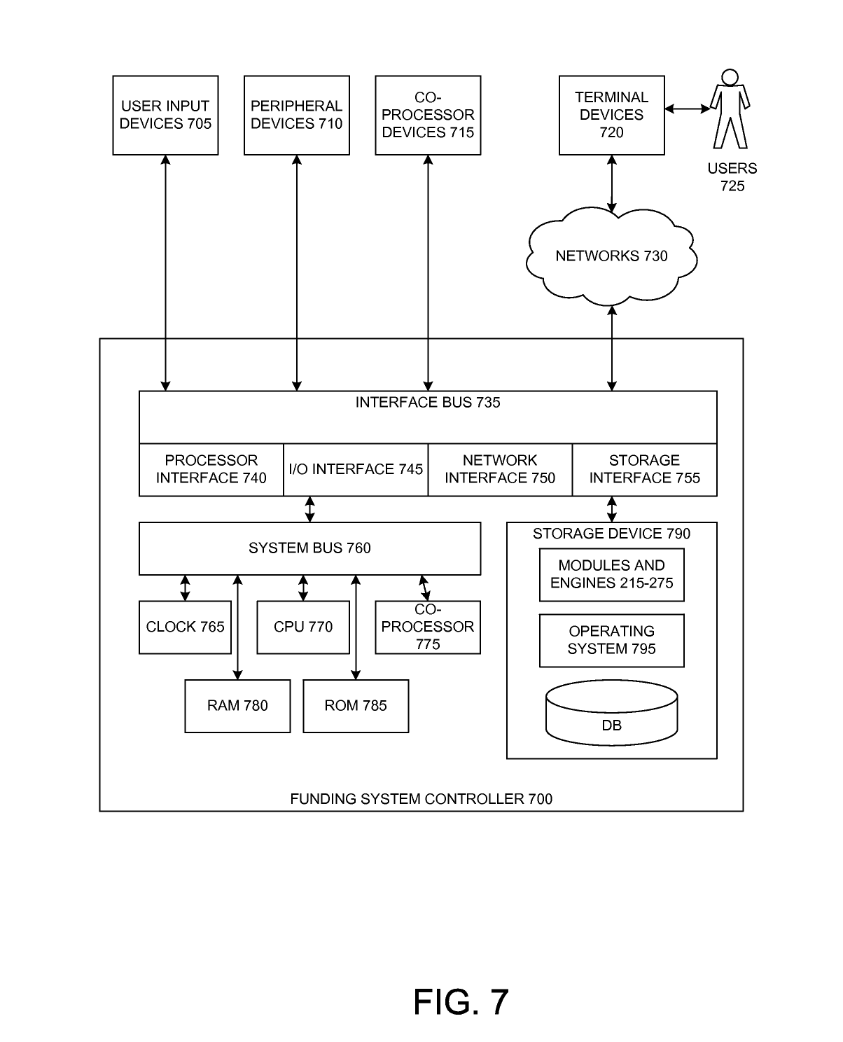

FIG. 4 is a flowchart illustrating a set of operations 400 for funding a pension plan in accordance with various aspects of the present invention. Many of the operations illustrated in FIG. 4 may be performed by funding platform 120 or any of the components or modules illustrated in FIG. 2, FIG. 7, or otherwise described through this disclosure. Funding platform 120 and the components or modules illustrated in FIG. 2 and/or FIG. 7 provide examples of the means which can be used to implement these operations.

As illustrated in FIG. 4, receiving operation 410 receives a request (e.g., an electronic request) from a plan sponsor for issuance of a secured note. In some cases, the request may include a variety of information about the pension plan which can be used to determine a suggested principal amount. In other cases, the request may include an amount the plan sponsor (or other third-party structure) desires to contribute to the plan. Once the contribution amount is set, escrow operation 420 sets up an escrow in an amount equal to the principal amount of the note as collateral. Once the collateral is deposited into the escrow account, linking operation 430 can link Note and the collateral in escrow to the pension plan.

The funding level of the pension plan can vary over time. In some aspects, the current funding level is computed (e.g., monthly, yearly, etc.) and indexing operation 440 adjusts the principal of the Note. For example, in some aspects, the principal of the Note may be automatically adjusted downward as the funded status of the plan improves. This adjustment may be a one way adjustment in some cases. In some aspects, the adjustment may occur based on threshold amount or timing triggers. For example, a minimum adjustment amount (e.g., $250,000) may be used in some versions of the Note. In one variant, as the amount is adjusted, these funds may be released from escrow.

Prior to maturity of the Note, the collateral may be release when a set of conditions are met. For example, if the level of collateral becomes equal to more than a set percentage (e.g., 150%) of the value of the Note, some of the collateral may be released. In some aspects, the plan's independent fiduciary may have a veto right to limit the plan sponsor's access to collateral. There may also be limits on the amount that may be released. For example, a plan sponsor may be able to obtain early release on a maximum of 50% of the initial collateral.

Upon reaching maturity, determination operation 450 determines the current funded status of the plan and the remaining amount in escrow. The collateral can be released and used to repay the Note so that the pension is currently fully funded with any excess returned to the plan sponsor.

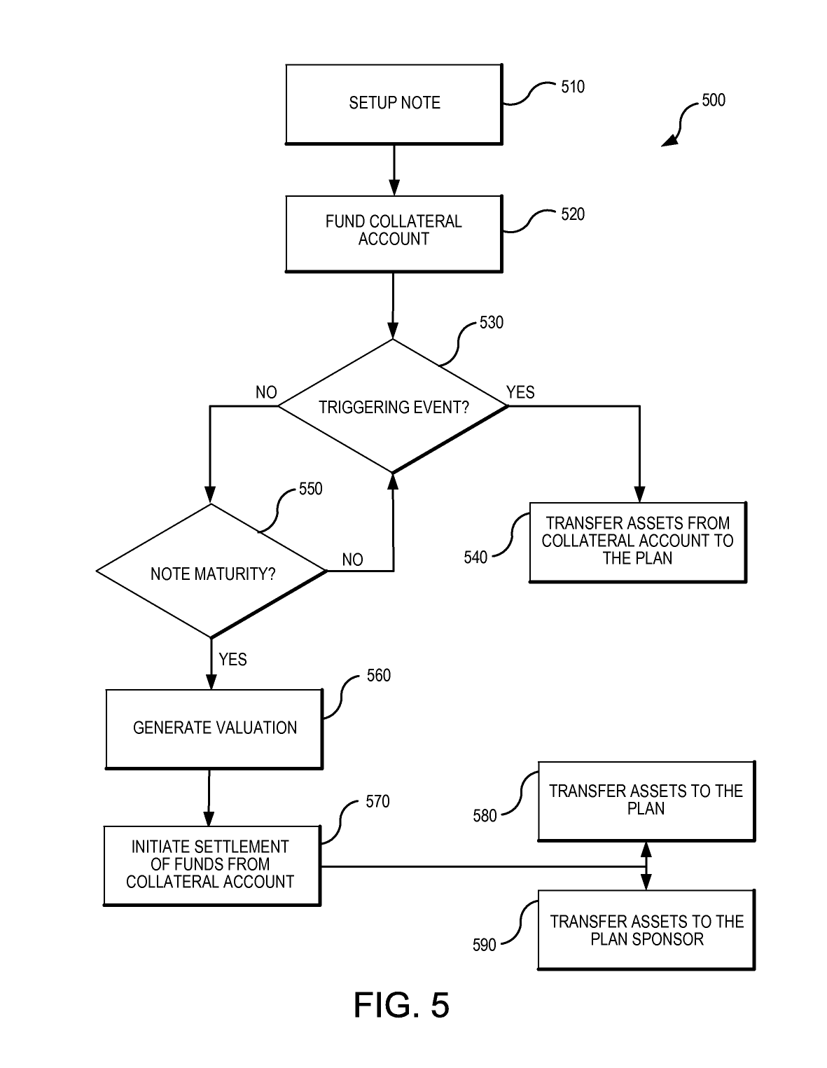

FIG. 5 is a flowchart illustrating a set of operations 500 for settling a secured pension note in accordance with various aspects of the present disclosure. Many of the operations illustrated in FIG. 4 may be performed by funding platform 120 or any of the components or modules illustrated in FIG. 2 and/or FIG. 7. Funding platform 120 and the components or modules illustrated in FIG. 2 and/or FIG. 7 provide examples of the means which can be used to implement these operations.

As illustrated in FIG. 5, setup operation 510 creates the Note by defining the terms and conditions. Funding operation 520 funds the collateral account. The funds may be supplied by a third-party, the plan sponsor, an insurance payout, or other entity or mechanism. Detection operation 530 monitors for one or more triggering events. If detection operation 530 detects one or more trigger events, detection operation 530 branches to transfer operation 540 where the assets are transferred from the collateral account to the pension plan. If detection operation 530 does not detect one or more trigger events, detection operation 530 branches to maturity determination operation 550 where a determination is made as to whether the Note has reached maturity.

If maturity determination operation 550 determines that the Note has not reached maturity, then maturity determination operation 550 branches back to detection operation 530 which monitors for one or more triggering events. If maturity determination operation 550 determines that the Note has reached maturity, then maturity determination operation 550 branches to valuation operation 560 where the value of the pension and the Note are generated. Using the current value of Note and the current funding level of the pension, settlement operation 570 initiates a settlement of funds from the collateral in accordance with the terms and conditions of the Note in view of the current funding level of the pension and value of the Note. For example, some or all of the funds may be transferred to the pension plan, the plan provider, or other third-party depending on the terms and conditions. Then transfer operations 580 and 590 transfer the assets to the plan and to the plan sponsor in accordance with the settlement determined by settlement operation 570.

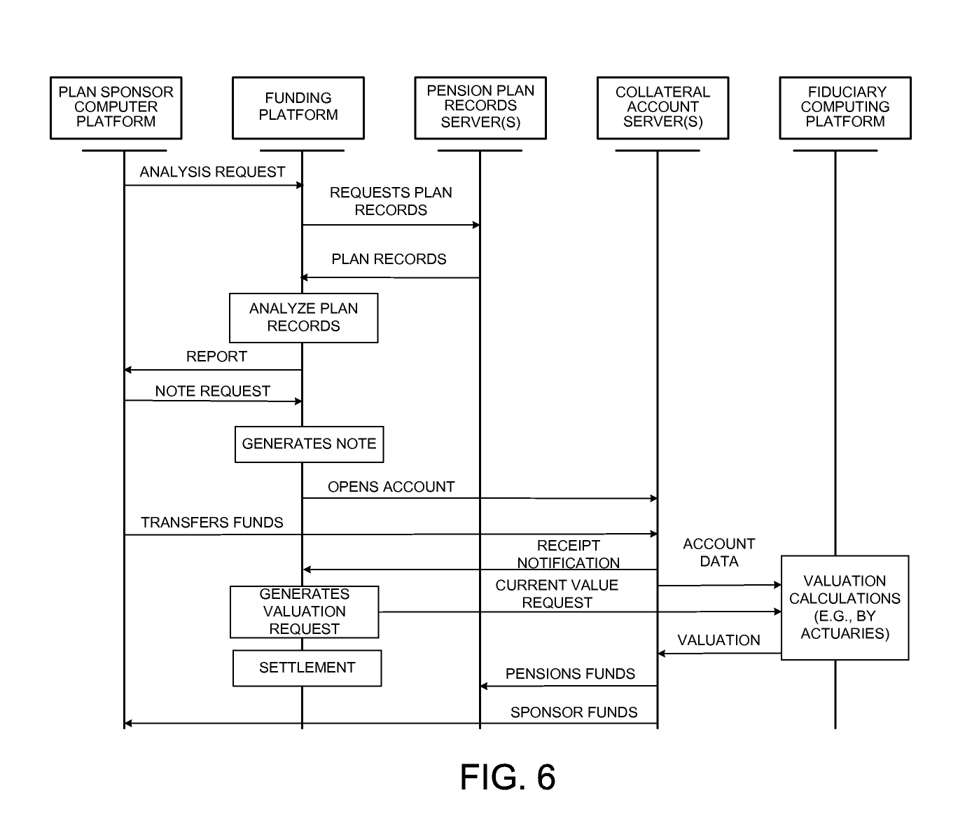

FIG. 6 is a sequence diagram illustrating communications between components within a networked-based environment for setting up and managing a Note in accordance with various aspects of the present disclosure. As illustrated in FIG. 6, a plan sponsor sends an analysis request to the funding platform from a plan sponsor computing platform. The funding platform processes the analysis request and pulls the plan records from a pension plan records server. The funding platform analyzes the plan records and generates a report which is sent to the plan sponsor computing platform. Using, for example, a graphical user interface, the plan sponsor is able to generate a note request which is sent to the funding platform which generates the Note.

Upon generating the Note, the funding platform can open one or more collateral accounts by sending a request to a collateral account server. Once opened, the plan sponsor can request a funds transfer to the collateral accounts. Upon confirmation of the funds, a notification receipt is sent to the funding platform. The funding platform can generate a current valuation request asking for a valuation of the pension plan. This request, along with data about the collateral account can be send to the fiduciary computing platform which can create a valuation calculation by generating signals to one or more fiduciaries or actuaries requesting the needed calculations. The response from the fiduciaries can then be recorded and stored in a database. Upon detection of a triggering event or maturity of the Note, the funding platform can generate a settlement plan and cause the funds from the collateral account to be dispersed to the pension plan or back to the plan sponsor.

### Exemplary Computer System Overview

Aspects and implementations of the pension funding system of the disclosure have been described in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. For example, the steps or operations may be performed by a combination of hardware, software, and/or firmware.

FIG. 7 is a block diagram illustrating an example machine representing the computer systemization of the pension funding system. The funding system controller 700 may be in communication with entities including one or more users 725 client/terminal devices 720 (e.g., devices 110A-110N), user input devices 705, peripheral devices 710, an optional co-processor device(s) 715 (e.g., cryptographic processor devices), and networks 730 (e.g., 115 in FIG. 1). Users may engage with the controller 700 via terminal devices 720 over networks 730.

Computers may employ a central processing unit (CPU) or processor to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

The controller 700 may include clock 765, CPU 770, memory such as read only memory (ROM) 785 and random access memory (RAM) 780 and co-processor 775 among others. These controller components may be connected to a system bus 760, and through the system bus 760 to an interface bus 735. Further, user input devices 705, peripheral devices 710, co-processor devices 715, and the like, may be connected through the interface bus 735 to the system bus 760. The interface bus 735 may be connected to a number of interface adapters such as processor interface 740, input output interfaces (I/O) 745, network interfaces 750, storage interfaces 755, and the like.

Processor interface 740 may facilitate communication between co-processor devices 715 and co-processor 775. In one implementation, processor interface 740 may expedite encryption and decryption of requests or data. Input output interfaces (I/O) 745 facilitate communication between user input devices 705, peripheral devices 710, co-processor devices 715, and/or the like and components of the controller 700 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 750 may be in communication with the network 730. Through the network 730, the controller 700 may be accessible to remote terminal devices 720. Network interfaces 750 may use various wired and wireless connection protocols such as, direct connect, Ethernet, wireless connection such as IEEE 802.11a-x, and the like.

Examples of network 730 include the Internet, Local Area Network (LAN), Metropolitan Area Network (MAN), a Wide Area Network (WAN), wireless network (e.g., using Wireless Application Protocol WAP), a secured custom connection, and the like. The network interfaces 750 can include a firewall which can, in some aspects, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 755 may be in communication with a number of storage devices such as, storage device(s) 790, removable disc devices, and the like. The storage interfaces 755 may use various connection protocols such as Serial Advanced Technology Attachment (SATA), IEEE 1394, Ethernet, Universal Serial Bus (USB), and the like.

User input devices 705 and peripheral devices 710 may be connected to I/O interface 745 and potentially other interfaces, buses and/or components. User input devices 705 may include card readers, finger print readers, joysticks, keyboards, microphones, mouse, remote controls, retina readers, touch screens, sensors, and/or the like. Peripheral devices 710 may include antenna, audio devices (e.g., microphone, speakers, etc.), cameras, external processors, communication devices, radio frequency identifiers (RFIDs), scanners, printers, storage devices, transceivers, and/or the like. Co-processor devices 715 may be connected to the controller 700 through interface bus 735, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The controller 700 may employ various forms of memory including on-chip CPU memory (e.g., registers), RAM 780, ROM 785, and storage devices 790. Storage devices 790 may employ any number of tangible, non-transitory storage devices or systems such as fixed or removable magnetic disk drive, an optical drive, solid state memory devices and other processor-readable storage media. Computer-executable instructions stored in the memory may include the funding platform 120 having one or more program modules such as routines, programs, objects, components, data structures, and so on that perform particular tasks or implement particular abstract data types. For example, the memory may contain operating system (OS) component 795, modules and other components, database tables, and the like. These modules/components may be stored and accessed from the storage devices, including from external storage devices accessible through an interface bus.

The database components can store programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, stack, structured text file (e.g., XML), table, and/or the like. Such data-structures may be stored in memory and/or in structured files.

The controller 700 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the controller 700 may be distributed electronically over the Internet or over other networks (including wireless networks). Those skilled in the relevant art(s) will recognize that portions of the funding system may reside on a server computer, while corresponding portions reside on a client computer. Data structures and transmission of data particular to aspects of the controller 700 are also encompassed within the scope of the disclosure.

### CONCLUSION

The above Detailed Description is not intended to be exhaustive or to limit the disclosure to the precise form disclosed above. While specific examples for the disclosure are described above for illustrative purposes, various equivalent modifications are possible within the scope of the disclosure, as those skilled in the relevant art(s) will recognize (e.g., the issuing, valuing, and redeeming of other types of debt securities, such as bills or bond, derivatives, or other types of options to facilitate the funding of a pension or retirement plan). For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or sub-combinations. Each of these processes or blocks may be implemented in a variety of different ways. Also, while processes or blocks are at times shown as being performed in series, these processes or blocks may instead be performed or implemented in parallel, or may be performed at different times.

In conclusion, the present disclosure provides novel systems, methods and arrangements for funding pensions. While detailed descriptions of one or more aspects of the disclosure have been given above, various alternatives, modifications, and equivalents will be apparent to those skilled in the art without varying from the spirit of the disclosure. For example, while the aspects described above refer to particular features, the scope of this disclosure also includes aspects having different combinations of features and aspects that do not include all of the described features.

What is claimed is:

1. A computer-implemented method for operating a funding platform running on a server, the computer-implemented method comprising:
receiving, via a network, an electronic note request from a plan sponsor to fund a pension plan using a secured pension note, wherein the electronic note request includes a principal amount;
opening an escrow account that is to be funded with the principal amount, wherein the escrow account is managed by an independent trustee in accordance with terms and conditions of the secured pension note;
linking, upon funding of the escrow account, a value of the secured pension note with a funding level of the pension plan; and
distributing, at the maturity of the secured pension note, dependent on the value of the secured pension note, funds from the escrow account to one or both of the pension plan and the plan sponsor.

2. The computer-implemented method of claim 1, wherein the electronic note request include a pension valuation request to determine the value of the note

3. The computer-implemented method of claim 2, further comprising generating the value of the note and sending an indication of an updated funding level to the plan sponsor.

4. The computer-implemented method of claim 2, wherein the principal amount of the secure pension note is sufficient to fund the pension plan to a specified level based on the current funding level of the pension plan.

5. The computer-implemented method of claim 4, wherein the specified level partially funds the pension plan, fully funds the pension plan, or overfunds the pension plan according to a valuation methodology.

6. The computer-implemented method of claim 1, further comprising monitoring a funding level of the pension plan on periodic schedule and, upon determining that the funding level has increased above a threshold, releasing a portion of the funds from the escrow account to the plan sponsor.

7. The computer-implemented method of claim 1, further comprising:
generating, at the maturity of the secured pension note, a final valuation of the pension plan; and
wherein distributing the funds from the escrow account are first allocated to fund the pension plan based on the final valuation of the pension plan with the remaining funds, if any, going to the plan sponsor.

8. The computer-implemented method of claim 1, further comprising processing interest payments from the plan sponsor in accordance with the set of terms and conditions of the secured pension note.

9. The computer-implemented method of claim 1, monitoring for one or more triggering events and upon detection of the one or more triggering events, transferring at least a portion of the funds from the escrow account to the pension plan.

10. The computer-implemented method of claim 9, wherein the one or more triggering events include bankruptcy of the plan sponsor.

11. The computer-implemented method of claim 1, further comprising, issuing the note, wherein the note is issued by the plan sponsor or a third-party.

12. The computer-implemented method of claim 1, wherein the plan sponsor purchases insurance to fund the escrow account.

13. The computer-implemented method of claim 1, further comprising generating an escrow funding schedule that indicates timing and amount of payments to the escrow account.

14. A funding platform comprising:
a memory;
one or more processors;
a note generation module, running on the one or more processors, to generate a set of terms and conditions of a secured pension note, wherein the terms and condition of the secured pension note include an initial principal amount and present value of interest payments;
an escrow module, running on the one or more processors, to set up a third-party collateral account with the initial principal amount and the present value of interest payments;
a monitoring module, running on the one or more processors, to monitor the funding level of the pension plan; and
an adjustment module, running on the one or more processors, to receive the funding level of the pension plan and adjust a value of the secured pension note.

15. The funding platform of claim 14, further comprising a valuation module, running on the one or more processors, to generate a first valuation of the pension plan and a second valuation of the secured pension note.

16. The funding platform of claim 15, further comprising a reporting module, running on the one or more processors, to generate a funding report based on the first valuation and the second valuation.

17. The funding platform of claim 15, further comprising an accounting module, running on the one or more processors, to determine a first amount of funds from the escrow to be transferred to the pension plan and a second amount of funds from the escrow, if any, to be transferred to the plan sponsor.

18. The funding platform of claim 14, further comprising a graphical user interface generation module to generate a graphical user interface allowing the plan sponsor to generate a request to setup a secured pension note.

19. A non-transitory computer-readable storage medium containing a set of instructions to cause one or more processors to:
receiving an electronic request from a plan sponsor to commit funds to a pension plan using a secured pension note, wherein the secured pension note sets forth a set of terms and conditions including a maturity date, an issuer, an initial principal amount, and a stated interest payable or accrued periodically until maturity;
funding an escrow account with the initial principal amount and additional collateral;
processing interest payments until the maturity of the secured pension note; and
distributing, at the maturity of the secured pension note, funds from the escrow account to one or both of the pension plan and the plan sponsor.

20. The non-transitory computer-readable storage medium of claim 19, wherein the set of instructions further cause the one or more processors to:
monitor for one or more triggering events; and
transfer assets from the escrow account to the pension plan in response to a detection of the one or more triggering events.

21. The non-transitory computer-readable storage medium of claim 20, wherein the one or more triggering events include bankruptcy of the plan sponsor or a failure to make stated interest payable set forth in the terms and conditions of the secured pension note.

22. The non-transitory computer-readable storage medium of claim 19, wherein the set of instructions further cause the one or more processors to:
generate a valuation of the secured pension note; and
initiate a settlement of funds from the escrow account upon maturity of the secured pension note.

23. The non-transitory computer-readable storage medium of claim 19, wherein the initial principal amount of the secure pension note is sufficient to fully fund the pension plan to a desired level based on the current funding level of the pension plan.

24. The non-transitory computer-readable storage medium of claim 19, wherein the set of instructions further cause the one or more processors to index the principal amount with a current funding level of the pension plan.

25. The non-transitory computer-readable storage medium of claim 19, wherein the additional collateral includes a present value of interest payments.

26. A system comprising:
means for tracking funding of an escrow account associated with a secured pension note and a pension plan;
means for processing interest payments of the secured pension note;
means for calculating, based on terms and conditions of the secured pension note, a distribution schedule; and
means for distributing funds, according to the distribution schedule, from the escrow account to at least one of a pension plan, a plan sponsor, or a third-party.
